(19) United States
(12) Patent Application Publication
(10) Pub. No.: US 2025/0034365 A1
(43) Pub. Date: Jan. 30, 2025

(54) COMPOSITE FILM AND MANUFACTURING METHOD THEREOF

(71) Applicants: LG ELECTRONICS INC., Seoul (KR); INHA UNIVERSITY RESEARCH AND BUSINESS FOUNDATION, Incheon (KR)

(72) Inventors: Junseok LEE, Seoul (KR); Dongjoo YOU, Seoul (KR); Jeayoul JOUNG, Seoul (KR); Seongmoon CHO, Seoul (KR); Jinkyun LEE, Incheon (KR); Seungsoo CHOI, Seoul (KR); Minkyu CHOI, Gyeonggi-do (KR)

(73) Assignees: LG ELECTRONICS INC., Seoul (KR); INHA UNIVERSITY RESEARCH AND BUSINESS FOUNDATION, Incheon (KR)

(21) Appl. No.: 18/709,264

(22) PCT Filed: Nov. 10, 2022
(86) PCT No.: PCT/KR2022/017655

§ 371 Date: May 10, 2024

(30) Foreign Application Priority Data
Nov. 12, 2021 (KR) 10-2021-0155996

(51) Int. Cl. C08K 9/08; B29C 43/22; C08F 292/00; C08J 5/18

(52) U.S. Cl. CPC C08K 9/08; B29C 43/22; C08F 292/00; C08J 5/18; C08J 2327/18; C08J 2351/10

(57) ABSTRACT

The present embodiment provides a composite film in which a plurality of composite inorganic particles, which are inorganic particles having a fluoropolymer coating film formed therein, are sintered to form a plane shape. Therefore, the low dielectric inorganic particle composite film may reduce signal loss by being hybridized with an interlayer insulator in a high-frequency 5G area. The low dielectric inorganic particles may minimize transmission loss by enhancing dielectric properties when applied to a 5G smartphone substrate and an IF cable, since the composite film used as an interlayer insulator for a communication substrate material comprises only the inorganic particles. In addition, application of the low dielectric inorganic particles may be expanded to vehicles, construction, and IoT products which will use 5G communication in the future.

### TECHNICAL FIELD

The present embodiment relates to a composite film applicable to the field of substrates for high-frequency circuits, and more particularly, to a composite film containing fluorinated inorganic particles and a method of manufacturing the same.

### BACKGROUND ART

With the advancement of communication technology, Internet speeds are becoming faster, and high-speed communication through the gigahertz (GHz) band is used in the 5G environment. The 5G standard supports millimeter (mm) wavelength communication, which corresponds to a frequency of about 28 GHz or higher.

The configuration of antenna on the communication module is implemented using a flexible printed circuit board (FPCB), and polyimide, a super heat-resistant polymer material, has been used as a material for the FPCB.

Polyimide has an advantage of continuously improving dielectric properties through change in the monomer composition when forming an antenna circuit.

However, the limit to supplementing dielectric properties through polyimide has been reached and especially, interlayer insulating materials with lower dielectric properties are required for high-frequency antennas.

### DISCLOSURE

### Technical Problem

It is one object of the present disclosure to provide a composite film that is combined with an interlayer insulator in a high-frequency 5G area to reduce signal loss and a method of manufacturing the same.

It is another object of the present disclosure to provide an inorganic composite film that is thermally stable even at high temperatures and can reduce dielectric constant and a method of manufacturing the same.

It is another object of the present disclosure to provide various modifications having similar properties by mixing the inorganic composite with an applicable resin as a main material.

### Technical Solution

In accordance with one aspect of the present disclosure, the above and other objects can be accomplished by the provision of a composite film having a configuration in which a plurality of composite inorganic particles including inorganic particles coated with a fluorinated polymer are sintered to form a plane shape.

The inorganic particles may be silica (SiO₂) particles.

The silica particles may be hollow silica or mesoporous silica particles.

The volume ratio of air contained in the film by the silica particles may be 4.8 to 20.6% with respect to the total weight of the composite film.

The fluorinated polymer may be located in at least a portion of pores of the silica particles.

The fluorinated polymer may be polytetrafluoroethylene (PTFE).

The composite film may be composed of only the composite inorganic particles.

The composite film may further include the fluorinated polymer.

The fluorinated polymer may be present as a powder in an amount of less than 15 w % of the composite film.

The fluorinated polymer may be the same material as the fluorinated polymer that forms the coating layer of the composite inorganic particles.

The fluorinated polymer may include a different material from the fluorinated polymer forming the coating layer of the composite inorganic particles.

The fluorinated polymer present as a powder may be a perfluoroalkoxy (PFA) resin.

In accordance with another aspect of the present disclosure, provided is a method of manufacturing a composite film including surface-treating inorganic particles, dispersing the inorganic particles in a solvent, polymerizing the inorganic particles with a fluorinated polymer coating to form composite inorganic particles provided with a coating layer, and pulverizing the composite inorganic particles, and injecting the pulverized composite inorganic particles into a mold, followed by pressing and sintering, to manufacture a composite film.

The surface-treating the inorganic particles may include treating the surface of the inorganic particles with reactive silane.

The surface-treating the inorganic particles may impart hydrophobicity to the inorganic particles.

The fluorinated polymer may be polytetrafluoroethylene (PTFE).

The forming the composite inorganic particles may include injecting the surface-treated inorganic particles and a polymerization initiator into a reactor, and injecting a tetrafluoroethylene (TFE) monomer into the reactor and performing emulsion polymerization.

The dispersing the inorganic particles in the solvent may include dispersing the inorganic particles in water in the presence of a fluorine-based emulsifier.

The inorganic particles may be silica (SiO₂) particles.

The composite film may be manufactured by injecting a fluorinated polymer powder along with the pulverized composite inorganic particles into a mold, followed by pressing and sintering.

The composite inorganic particles may be present in an amount of 85 wt % or more based on the total weight of the composite film.

### Advantageous Effects

In accordance with Technical Solution, it is possible to provide a low-dielectric inorganic particle composite film that is combined with an interlayer insulator in the high-frequency 5G area to reduce signal loss.

Such low-dielectric inorganic particles can minimize transmission loss by improving dielectric properties when applied to 5G cellular phone substrates and IF cables using a composite film composed only of the inorganic particles as an interlayer insulator of a communication substrate material. In addition, low-dielectric inorganic particles can be expanded to automotive, architectural, and IoT products that will utilize 5G communications in the future.

In addition, by chemically bonding fluorinated polymers to inorganic particles through polymerization of fluorine-based monomers on the surface of the inorganic particles, it is possible to provide organic/composite inorganic particles that are thermally stable even at high temperatures and have reduced dielectric constant and hygroscopicity.

In addition, the fluorinated polymer coating imparts hydrophobicity to the hydrophilic inorganic particles, thereby lowering hygroscopicity, and the inorganic particles on which the coating is formed can also have a low dielectric constant using the low dielectric properties inherent to the fluorinated polymer.

Furthermore, according to another embodiment, there are additional technical effects not mentioned herein.

### DESCRIPTION OF DRAWINGS

FIG. 1 is a diagram illustrating the configuration of a composite film according to an embodiment of the present disclosure.

FIG. 2 is a schematic diagram illustrating an example of silica particles of a composite film according to an embodiment of the present disclosure.

FIG. 3 is a schematic diagram illustrating another example of silica particles of a composite film according to an embodiment of the present disclosure.

FIG. 4 is a flowchart illustrating a process of manufacturing a composite film according to an embodiment of the present disclosure.

FIG. 5 is a schematic diagram illustrating a process of manufacturing composite inorganic particles according to an embodiment of the present disclosure.

FIG. 6 is an image showing composite inorganic particles according to an embodiment of the present disclosure.

FIG. 7 shows particle size analysis of composite inorganic particles according to an embodiment of the present disclosure.

FIGS. 8 and 9 are graphs showing the characteristics of composite inorganic particles according to an embodiment of the present disclosure.

FIG. 10 is a schematic diagram illustrating a process of manufacturing a composite film according to an embodiment of the present disclosure.

FIG. 11 is an image showing the top surface of the composite film manufactured through the process of FIG. 10.

FIG. 12 is an image showing the cross-section of the composite film of FIG. 11.

FIG. 13 is a schematic diagram illustrating another embodiment of the composite film of FIG. 11.

FIG. 14 is an image showing the top surface of the composite film of FIG. 13 and the top surface of the comparative example.

### BEST MODE

The use of terms such as “first” and “second” in front of the components mentioned below is only to avoid confusion about the components referred to, and is unrelated to the order, importance, or superior-subordinate relationship between components. For example, an embodiment including only the second component without the first component can also be implemented.

Furthermore, although each drawing is described for convenience of explanation, another embodiment can be implemented by those skilled in the art by combining at least two or more drawings, which falls within the scope of the present disclosure.

It will be understood that when an element such as a layer, region or substrate is referred to as being “on” another element, it may be directly on the other element or intervening elements may also be present.

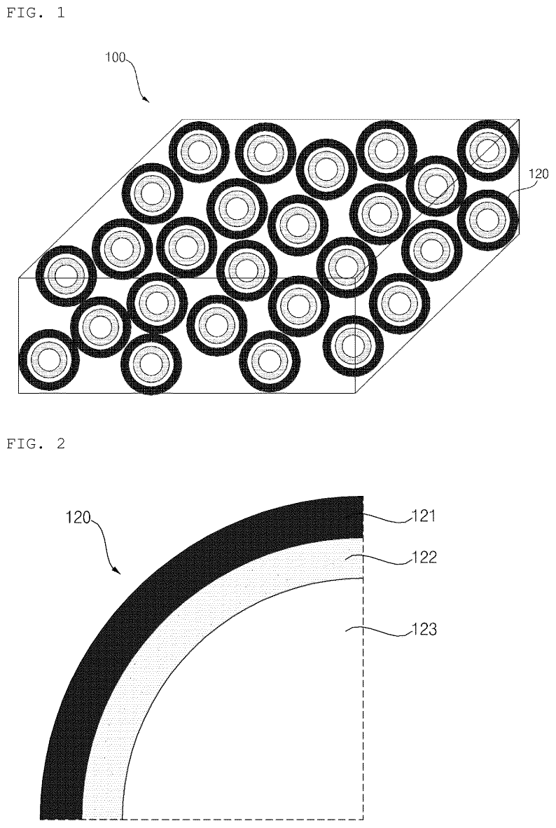

FIG. 1 is a diagram illustrating the configuration of a composite film according to an embodiment of the present disclosure.

Referring to FIG. 1, the composite film 100 includes a plurality of composite inorganic particles 120 having a configuration in which a fluorinated polymer (a fluorinated polymer coating) is formed on inorganic particles to form voids between the adjacent composite inorganic particles 120.

These inorganic particles 120 may be silica particles (SiO₂; 122 or 125). For example, the silica particles may be hollow silica or mesoporous silica particles.

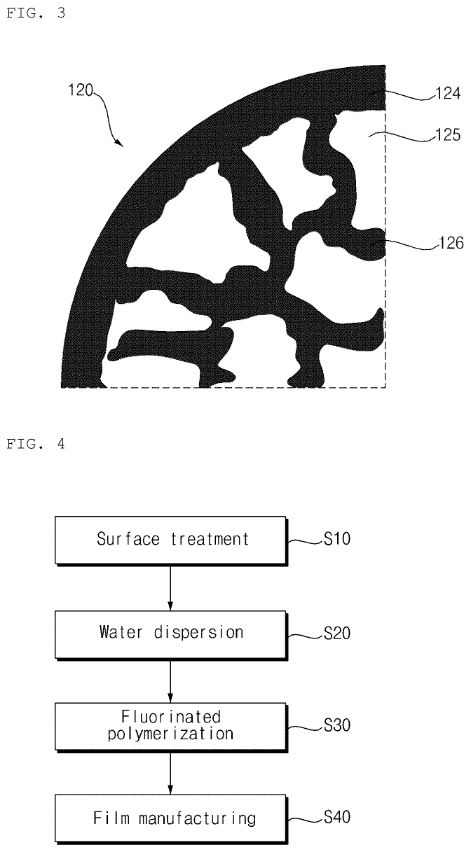

FIG. 2 is a schematic diagram illustrating an example of silica particles of a composite film according to an embodiment of the present disclosure and FIG. 3 is a schematic diagram illustrating another example of silica particles of a composite film according to an embodiment of the present disclosure.

First, FIG. 2 illustrates an example in which hollow silica 122 is used as the inorganic particle 120. FIG. 2 schematically shows a portion of a spherical particle. Hollow silica 122 is a silica particle having a configuration in which a hollow 123 is present inside a spherical particle. The hollow 123 is filled with air.

A fluorinated polymer coating 121 may be formed outside the hollow silica 122. The fluorinated polymer coating 121 may coat the entire outer surface of the hollow silica particles 122.

As shown in FIG. 2, the hollow silica 122 may have a configuration in which the hollow 123 meaning a spherical internal space is filled with air and a silica (SiO₂) shell with a substantially uniform thickness is located outside the hollow 123. The fluorinated polymer coating 121 may be located to have a substantially uniform thickness outside of the silica shell.

Alternatively, as shown in FIG. 3, the inorganic particles 120 may be mesoporous silica 125. Like FIG. 2, FIG. 3 schematically shows a portion of a spherical particle. Mesoporous silica 125 refers to a silica particle in the form of a spherical particle having holes 126 communicated with each other.

The pores 126 of the mesoporous silica 125 in a natural state may be filled with air, but the fluorinated polymer of the fluorinated polymer coating 124 may be located in the pores 126 of the mesoporous silica 125 used as the inorganic particles 120 according to an embodiment of the present disclosure.

That is, the pores 126 of the mesoporous silica 125 may be at least partially filled with the fluorinated polymer during formation of the fluorinated polymer coating 124. FIG. 3 is a schematic diagram illustrating another example of silica particles of a composite film according to an embodiment of the present disclosure.

For example, the fluorinated polymer and the fluorinated polymer coatings 121 and 124 may contain polytetrafluoroethylene (PTFE).

For example, the composite film 100 may form a matrix in which a plurality of inorganic particles 120 is solidified in the form of granules or powder.

The fluorinated polymer coating 121 aims at reducing at least one of dielectric constant and hygroscopicity of the composite film 100.

When silica particles 122 are used as inorganic particles as above, the volume ratio of air contained in the composite film 100 by the silica particles 122 may be 4.8 to 20.6% of the total weight of the composite film 100.

For example, the size of the inorganic particles 120 may be 100 to 1,000 nm. Here, the size of the inorganic particle 120 may mean the diameter of the inorganic particle 120.

When the size of the inorganic particles 120 is smaller than 100 nm, particle aggregation may increase after coating with the fluorinated polymer, resulting in thickness imbalance.

In addition, when the size of the inorganic particles 120 is larger than 1,000 nm, the surface of the composite film 100, which is manufactured as a commonly used composite film having a thickness (for example, 25 μm or 50 μm) for printed circuit board materials, may be nonuniform.

Meanwhile, the thickness of the fluorinated polymer coatings 121 and 124 may be 10 to 60 nm.

The coating thickness of the fluorinated polymer coatings 121 and 124 may vary depending on the content of the surfactant, initiator, and fluorine monomer used in manufacturing the composite film 100.

At this time, when the coating thickness of the fluorinated polymer coatings 121 and 124 is less than 10 nm, the effect of reducing the moisture absorption rate of silica may be greatly reduced. In addition, when the coating thickness of the fluorinated polymer coatings 121 and 124 is greater than 60 nm, the amount of homopolymer produced by polymerization of only fluorine groups may increase due to excessive polymerization. In addition, the degree to which aggregation of the inorganic particles 120 occurs may increase.

Meanwhile, the content of the fluorinated polymer coatings 121 and 124 may correspond to 10 to 30 weight percentage (wt %) of the total weight of the inorganic particles 120. As Internet access speeds become increasingly faster due to advancements in communication technology, the 5G standard has a millimeter wavelength (mm), which corresponds to a frequency of approximately 28 GHz or higher.

Polyimide, a super heat-resistant polymer material, has been used to date as a material for FPCBs, but has a problems of large dielectric loss and thus great transmission loss.

Therefore, according to the present embodiment, it is possible to provide a fine composite film 100 using low-dielectric polymer-inorganic composite inorganic particles 120 that can reduce signal loss by combination with an interlayer insulator in the high-frequency 5G area.

The composite inorganic particles 120 are not used as a filler dispersed in polyimide, but are used alone or as a main material to restrict the application of polyimide and thereby minimize transmission loss by improvement of dielectric properties. In addition, the composite inorganic particles are expected to be expanded to automotive, architectural, and IoT products that will utilize 5G communication in the future.

As described above, according to the present embodiment, the fluorinated polymer is chemically bonded to the inorganic particles through polymerization of the fluorine-based monomer on the surface of the inorganic particles, thereby producing an organic/inorganic composite inorganic particle 120 that is thermally stable even at high temperatures and has reduced dielectric constant and hygroscopicity.

In addition, the composite film 100 having these characteristics may be manufactured using the composite inorganic particles 120 alone or as a main material.

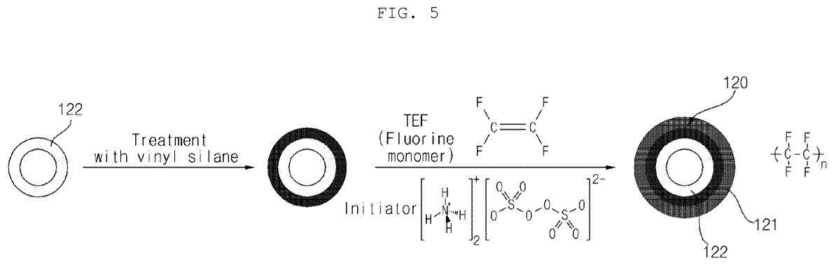

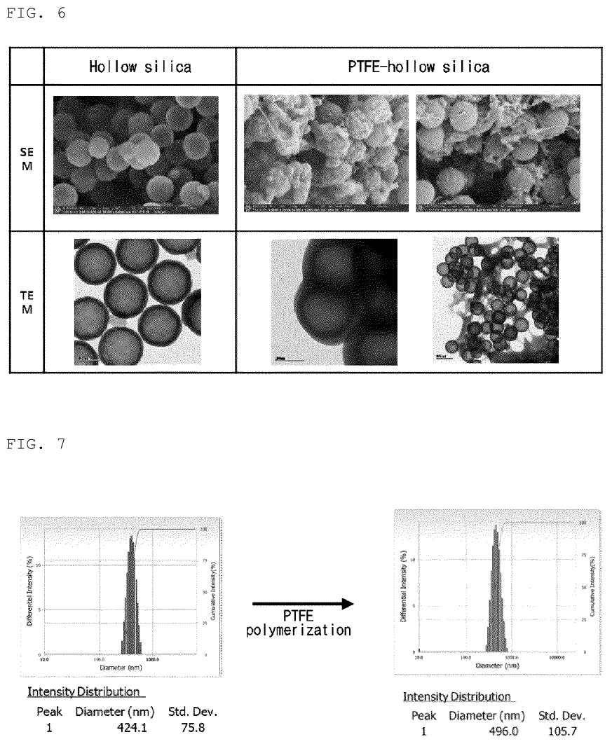

FIG. 4 is a flowchart illustrating a process of manufacturing a composite film according to an embodiment of the present disclosure. FIG. 5 is a schematic diagram illustrating a process of manufacturing composite inorganic particles according to an embodiment of the present disclosure.

Hereinafter, the process of manufacturing the composite film according to an embodiment of the present disclosure will be described in detail with reference to FIGS. 4 and 5.

According to this manufacturing process, a fluorinated polymer is chemically bonded to inorganic particles (for example, silica particles) through polymerization of a fluorine-based monomer on the surface of the inorganic particles to produce inorganic particles 120 and then the inorganic particles 120 are mixed with a polyamic acid solution to manufacture a composite polyimide thin film.

Hereinafter, a case in which the inorganic particles are silica particles will be described as an example. That is, in the following description, inorganic particles may mean silica particles, but the present disclosure is not limited thereto.

In general, hollow silica or porous inorganic particles are hydrophilic and thus have the disadvantage of increased hygroscopicity when used as a substrate material utilizing low dielectric constant. According to the present embodiment, in order to overcome these disadvantages, a fluorinated polymer coating may be formed on the surface of hollow silica or porous inorganic particles.

In the process of sintering the inorganic particles provided with the fluorinated polymer coating to form a film, heat treatment (imidization) at a temperature as high as 400° C. may be required. At this time, the fluorinated polymer coating is fixed on the surface of the inorganic particle based on high thermal stability thereof and can maintain the low dielectric constant and low hygroscopicity as described above.

With reference to FIGS. 4 and 5, the specific process of manufacturing the composite film according to an embodiment of the present disclosure will be described as follows.

First, surface-treating the inorganic particles used as the inorganic particles 120 (S10) may be performed. Silica particles 122 may be used as an example of such inorganic particles.

Referring to FIG. 5, silica particles (SiO₂) before surface treatment may be provided with a hydroxyl group.

The hydroxyl group forms a hydrogen bond between functional groups and the hydrogen bond may provide affinity for water.

According to an embodiment, surface-treating the inorganic particles (S10) may include treating the surface of the inorganic particles with reactive silane. The surface-treating the inorganic particles S10 may impart hydrophobicity to the inorganic particles 122.

The surface-treating the inorganic particles 122 (S10) may include surface-treating silica or inorganic particles having pores with reactive silane having a vinyl or methacrylate group (treatment with vinyl and methacrylate silane).

In other words, silica or inorganic particles having pores are added to an organic solvent such as methanol, tetrahydrofuran, ethanol, or dichloromethane, and then vinyl silane (vinyl triethoxysilane, 3-(trimethoxysilyl)propyl methacrylate, or the like) is added thereto to treat the surface of the silica or inorganic particles with silane.

As a result, compatibility between silica particles and TFE monomers may be secured during emulsion polymerization of fluorinated polymers (for example, PTFE), and an anchoring site may be established on the surface of the silica particles.

The fluorinated polymer may be polytetrafluoroethylene (PTFE).

Then, the surface-treated inorganic particles are dispersed in a solvent (S20).

Here, the solvent may be water. That is, the process of dispersing the surface-treated inorganic particles in a solvent may be water dispersion.

In the step of dispersing the inorganic particles in a solvent (S20), the inorganic particles may be dispersed in water in the presence of a fluorine-based emulsifier.

Specifically, silica particles (for example, hollow silica) treated with vinyl silane may be added to a small amount of fluorine-based emulsifier used in emulsion polymerization of PTFE, followed by dispersion in water. That is, the hollow silica and the fluorine-based emulsifier may be added to deionized water (DI-water) and the silica particles may be dispersed in water using a sonicator.

Here, the fluorine-based emulsifier may be PFOA (perfluorooctanoic acid), perfluoro-3,6,9-trioxadecanoic acid, perfluoro(2,5-dimethyl-3,6-dioxanonanoic acid) or the like. At this time, an aqueous ammonia solution is added to adjust the pH to 7.

Then, the fluorinated polymer coating may be polymerized on the inorganic particle to form the composite inorganic particle 120 (S30).

According to an exemplary embodiment, the step of forming the composite inorganic particles 120 (S30) includes injecting the surface-treated inorganic particles 122 and a polymerization initiator into a reactor, injecting a tetrafluoroethylene (TFE) monomer thereto, and performing emulsion polymerization.

Vinylsilane-treated inorganic particles and the polymerization initiator (ammonium persulfate; APS) are injected into a high-pressure reactor and heated to a predetermined temperature (e.g., 80° C.).

Then, after degassing, a gaseous tetrafluoroethylene (TFE) monomer is added and emulsion polymerization is performed while stirring.

The silica particles 122 provided with the fluorinated polymer coating 121 may be naturally phase-separated and recovered from the emulsion polymerization result. When the pressure decreases by 0.76 bar, stirring is stopped and the temperature is lowered to room temperature.

At this time, the composite inorganic particles 120 are recovered by filtration, thoroughly washed with purified water, dried at low pressure and 100° C. for 24 hours, and then recovered.

Through this process, composite inorganic particles 120 on which the fluorinated polymer coating 121 is formed may be produced.

Then, a composite film may be produced using the composite inorganic particles 120 provided with the fluorinated polymer coating 121 prepared through emulsion polymerization is formed (S40).

Hereinafter, specific embodiments will be described in detail for each step.

### Example 1

Manufacturing of surface-treated hollow silica

The mesoporous silica or hollow silica dispersion with pores in an organic solvent was injected into a container (flask), and ethanol and purified water were added thereto, followed by stirring for 1 hour and ultrasonication for 20 minutes, to obtain a uniform dispersed phase. At this time, the hollow silica in the hollow silica dispersion may satisfy 20 wt/vol % and the volume ratio of the hollow silica dispersion to ethanol to purified water may satisfy 6:2:2.

Then, an aqueous ammonia solution and 3-(trimethoxy silyl) propyl methacrylate were added to the mixed dispersion, followed by stirring at room temperature for 24 hours. At this time, on a volume basis, a ratio of the mixed dispersion to the aqueous ammonia solution to silane compound may be 10:1:1.

The solvent may be removed from the mixed dispersion containing an aqueous ammonia solution through reduced pressure distillation, and then the remaining hollow silica residue may be redispersed in purified water and recovered through a filtration process. The filtered particles may be further washed with hexane.

Then, the recovered hollow silica may be dried at 100° C. for 24 hours under reduced pressure conditions to complete surface treatment.

### Preparation of Surface-Treated Hollow Silica Aqueous Dispersion Solution Before Emulsion Polymerization

Distilled water and a fluorine-based emulsifier were added to a container (beaker), and an appropriate amount of aqueous ammonia solution was added thereto to adjust the pH to 7. For example, 1 g of perfluoro(2,5-dimethyl-3,6-dioxanonanoic acid) is added to 500 mL of distilled water, and an appropriate amount of aqueous ammonia solution was added thereto to adjust the pH to 7. At this time, 10 g of surface-treated hollow silica was added to the prepared aqueous fluorination solution and dispersed using a homogenizer until there were no settled particles to prepare an aqueous dispersion solution.

Production of Hollow Silica Provided with Fluorinated Polymer Coating

The previously prepared porous silica or hollow silica particle dispersion and 0.48 g of ammonium persulfate as an initiator were injected into the high pressure reactor, followed by stirring at 200 rpm.

To remove residual oxygen, N₂ bubbling was performed for 20 minutes to purge the atmosphere of the reactor with nitrogen and the pressure was reduced using a vacuum pump.

In addition, for additional degassing, the atmosphere of the reactor was replaced with N₂ and TFE (tetrafluoroethylene) gas and the pressure was reduced.

After the reactor temperature was raised to 80° C. and the stirring speed was increased to 500 rpm, a gaseous tetrafluoroethylene (TFE) monomer was added thereto, followed by stirring to start the reaction.

Then, polymerization was performed until the pressure of the tetrafluoroethylene (TFE) monomer in the reactor dropped to 1.52 bar and the TFE gas was exhausted to terminate the reaction.

The solution in which the polymer has precipitated was cooled to room temperature, and the composite inorganic particles were recovered by filtration, washed thoroughly with purified water, and dried at low pressure and at 100° C. for 24 hours to obtain silica or hollow silica having pores coated with the fluorinated polymer.

According to the manufacturing method of the present embodiment, composite inorganic particles 120 including silica or inorganic particles having pores whose surface is coated with a fluorinated polymer may be formed.

In other words, a coating may be formed on the surface of hydrophilic silica or inorganic particles through fluorinated polymer polymerization.

The fluorinated polymer coating provides hydrophobicity to the hydrophilic inorganic particles to lower hygroscopicity, and the composite inorganic particles 120 provided with the coating formed using the inherent low dielectric properties of the fluorinated polymer may also have a low dielectric constant.

The characteristics of the composite inorganic particles 120 according to the present embodiment can be seen from FIGS. 6 to 9.

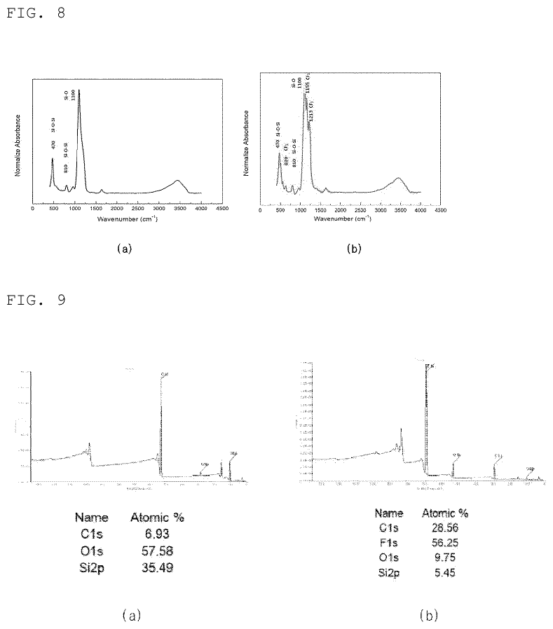

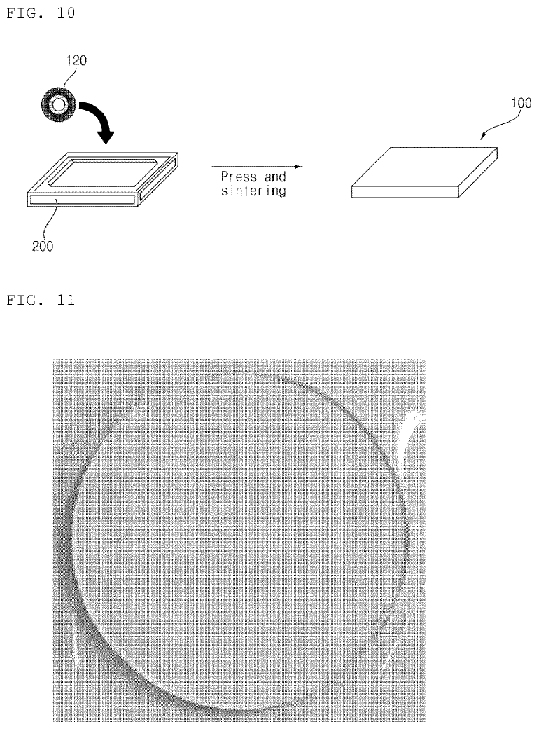

FIG. 6 is an image showing composite inorganic particles according to an embodiment of the present disclosure. FIG. 7 shows particle size analysis of composite inorganic particles according to an embodiment of the present disclosure. FIGS. 8 and 9 are graphs showing the characteristics of composite inorganic particles according to an embodiment of the present disclosure.

FIG. 6 is SEM and TEM images for comparing the hollow silica not provided with a fluorinated polymer coating and the composite inorganic particle provided with a fluorinated polymer coating according to the present embodiment, and FIG. 7 confirms coating formation through particle size analysis of hollow silica not provided with a fluorinated polymer coating and the composite inorganic particles provided with a fluorinated polymer coating according to the present embodiment.

As can be seen from the SEM and TEM images of FIG. 6, when hollow silica before polymerization and the prepared PTFE-hollow silica composite inorganic particles are observed, the PTFE polymer is attached to the surface of the silica inorganic particles through polymerization.

In addition, as shown in FIG. 7, the results of particle size analysis using dynamic light scattering (DLS) performed by dispersing hollow silica and PTFE-hollow silica composite particles in ethanol show that the particle size (a) of hollow silica before polymerization was about 424 nm, whereas the particle size (b) of the composite inorganic particles was increased to about 496 nm after polymerization of PTFE, a fluorinated polymer.

Referring to FIGS. 8 and 9, FIG. 8 shows the results of structural analysis based on FT-IR of pellets produced from hollow silica not provided with a fluorinated polymer coating and PTFE-hollow silica according to the present embodiment, along with KBr.

Referring to FIG. 8, hollow silica (a) before polymerization with fluorinated polymer shows only Si—O—SI and Si—O peaks appear at 470, 810, and 1,100 cm⁻¹, while PTFE-hollow silica (b) shows —CF₂ and —CF₃ peaks at only 639 cm⁻¹, 1,155 and 1,213 cm⁻¹, indicating PTFE coating.

In addition, FIG. 9 shows the results of composition element analysis based on XPS of powders produced from hollow silica not coated with fluorinated polymer and the PTFE-hollow silica according to the present embodiment.

As can be seen from FIG. 9, only C1s, O1s, and Si2p peaks are observed in the hollow silica before polymerization (a), while F1s is additionally observed in the recovered PTFE-hollow silica composite particles (b). Therefore, it can be seen that the recovered PTFE-hollow silica composite particles (b) are coated with PTFE.

As such, the composite film 100 may be produced from the composite inorganic particles 120 coated with the fluorinated polymer in accordance with the method as shown in FIG. 4.

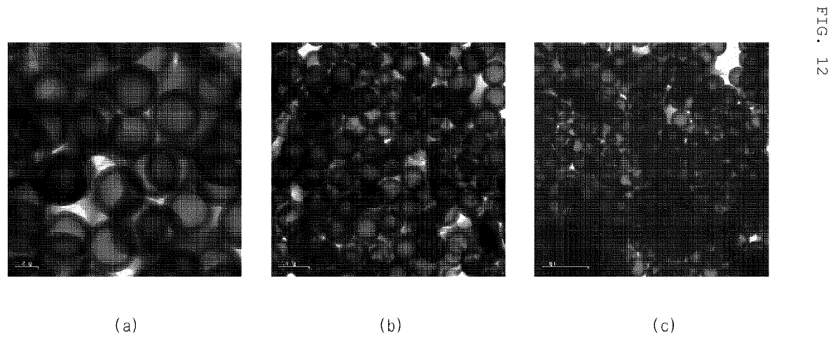

Hereinafter, the composite film 100 of FIG. 4 will be described with reference to FIGS. 10 to 12.

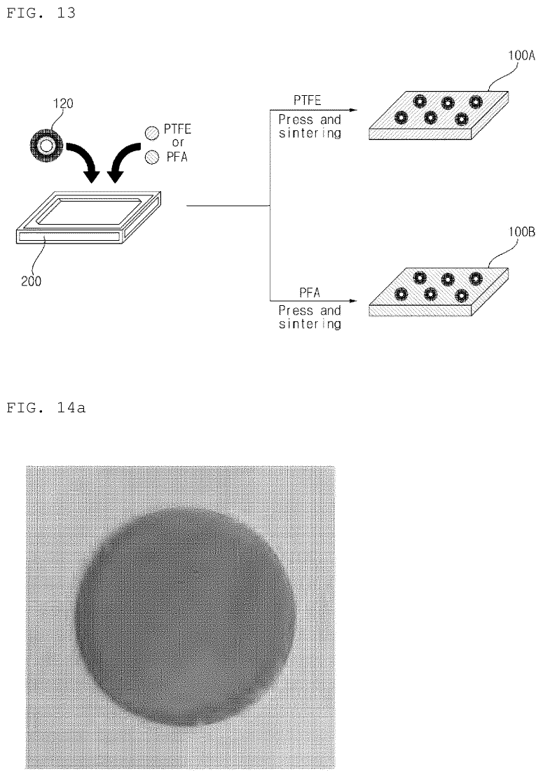

FIG. 10 is a schematic diagram illustrating a process of manufacturing a composite film according to an embodiment of the present disclosure. FIG. 11 is an image showing the top surface of the composite film manufactured through the process of FIG. 10. FIG. 12 is an image showing the cross-section of the composite film of FIG. 11.

Referring to FIG. 10, the PTFE-hollow silica composite inorganic particles 120 prepared in <Example 1> are finely pulverized in a mortar or a ball mill. The pulverized PTFE-hollow silica composite particle powder may be injected into a mold 200 to produce a composite substrate through a hydraulic press.

The substrate produced through the mold 200 may be sintered in a heating furnace at 360° C. for 4 hours to produce a composite film 100.

Through the high-pressure and high-temperature pressing and sintering process, a composite film 100 composed only of the PTFE-hollow silica composite inorganic particles 120 can be produced without using other resins.

As shown in FIG. 11, the composite film 100 has a milky white color and the fluorinated polymer coating 121 formed on the surface of the inorganic particle 122 has high thermal stability and thus stably binds to the particle surface even at high heat treatment temperatures, without causing loss of characteristics.

In addition, as can be seen from the cross-sectional TEM image of FIG. 12, when the substrate was cut through microtoming and the cross section was observed through cross-section TEM, hollow structures and voids between composite inorganic particles can be observed from the TEM image at various magnifications.

Therefore, the fluorinated polymer coating 121 was not detached and was still bonded even during the high temperature sintering process.

The composite film 100 may be produced into a film by pressing and sintering the fluorinated polymer-coated composite inorganic particles 120 without using other resins.

The composite film 100 thus formed may have lower dielectric properties than conventionally widely applied silicon oxide.

TABLE 1

| | 1 GH | 3.1 GH | 5.2 GH | 7.3 GH | 9.4 GH |
|---|---|---|---|---|---|
| Comparative | 4.43 | 4.43 | 4.43 | 4.43 | 4.42 |
| Example 1-SiO₂ | | | | | |
| Comparative | 2.03 | 2.03 | 2.03 | 2.03 | 2.03 |
| Example 2-PTFE | | | | | |
| Example 1 | 1.82 | 1.81 | 1.81 | 1.81 | 1.81 |
| Example 2 | 1.84 | 1.80 | 1.78 | 1.77 | 1.76 |

Table shows the dielectric constant measure at various frequencies using a microwave dielectrometer (manufacturer: AET Japan).

Comparative Example 1 shows the dielectric constant at various frequencies of silicon oxide, which is widely used as a dielectric layer or insulating layer in circuit boards or semiconductor devices of electronic devices.

Comparative Example 2 shows the dielectric constant of, as an insulating layer, a resin layer composed only of PTFE, a fluorinated polymer resin, used as a coating layer in the present embodiment.

Example 1 shows the dielectric constant at various frequencies of the composite film prepared by <Example 1> of the present embodiment.

Example 2 shows a composite film 100′ formed through the subsequent process of FIG. 4 by dispersion in water using the PTFE-hollow silica composite particles 120 obtained without surface treatment (S10) in <Example 1> of the present embodiment.

It can be seen that the composite films 100 of Examples 1 and 2 have a much lower dielectric constant than Comparative Example 1, which is silica. In addition, compared to films made of only PTFE resin, a lower dielectric constant can be secured through formation of the internal hollow.

Although the frequency increases, the dielectric constant does not significantly increase and changes within a predetermined range. Therefore, a low dielectric constant can be secured even when applied to the dielectric layer of a circuit board such as an antenna in a wireless communication system based on a higher frequency.

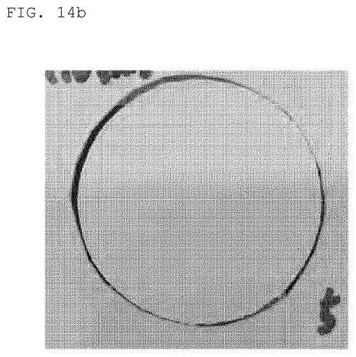

Meanwhile, in this embodiment, modifications to the embodiments such as those shown in FIGS. 13 and 14 are possible.

FIG. 13 is a schematic diagram illustrating another embodiment of the composite film of FIG. 11. FIG. 14 is an image showing the top surface of the composite film of FIG. 13.

Referring to FIG. 13, as Modification Example of the present disclosure, the PTFE-hollow silica composite inorganic particles 120 in FIG. 4 are formed and then are produced in the form of a substrate in a mold with a fluorinated resin.

### Modification Example 1

Specifically, 0.45 g of PTFE-hollow silica composite inorganic particles 120 and 0.05 g of a PTFE powder were finely ground in a mortar or a ball mill.

The finely pulverized PTFE-hollow silica and PTFE powder were injected into a mold 200 and pressed through a hydraulic press to produce a composite substrate.

The composite substrate thus produced was sintered at 360° C. for 4 hours in a heating furnace to produce a composite film 100A according to Modification Example 1.

The fluorinated resin used herein may be PTFE used as a coating layer of the composite inorganic particles 120. Alternatively, a PFA (perfluoroalkoxy) resin may be used to produce a composite film 100B.

At this time, the PFA resin may be used in an amount of about 10% by weight of the total weight, like the PTFE resin.

Therefore, the composite films 100A and 100B contain, as a main component, composite inorganic particles coated with a fluorinated polymer, and only about 10 w % of a fluorinated polymer powder.

The further contained fluorinated polymer powder fills the voids between each composite inorganic particle 120 during sintering, thereby maintaining heat resistance and a low thermal expansion coefficient, which are inherent characteristics of the fluorinated polymer.

Referring to FIG. 14, FIG. 14A is an image showing a composite film 100A prepared by mixing 0.45 g of PTFE-hollow silica composite particles with 0.05 g of a PTFE powder as in Comparative Example 1, and FIG. 14B is an image showing a composite film produced only from the PTFE resin in Comparative Example 2 of Table 1.

When comparing FIG. 14A with FIG. 14B, it can be seen that the composite film made of only PTFE resin is darker in color and that the composite inorganic particles 120 are evenly dispersed between the PTFE resin.

Modification Example shows that a composite film can be formed by mixing about 10% of the fluorinated polymer powder with respect to the total weight and this amount enables the voids between the composite inorganic particles to be filled, maintains a low dielectric constant due to the characteristics of the composite inorganic particles 120, and maintains a low thermal expansion coefficient, which is a characteristic of the fluorinated polymer.

Therefore, the fluorinated polymer powder does not exceed 15 w %.

Therefore, in the present embodiment, the composite inorganic particles 120 may be present in an amount of 85 w % or more and 100% or less with respect to the total weight of the film 100.

The composite film 100 produced from the composite inorganic particles 120, as the main component, may be applied as an insulating layer or dielectric layer of a printed circuit board.

The printed circuit board with a circuit pattern formed on the composite film 100 can achieve low dielectric constant, low dielectric loss, and low coefficient of thermal expansion.

The description above is provided only for illustration of the scope of the present disclosure. Those skilled in the art will appreciate that various modifications, additions and substitutions are possible, without departing from the scope and spirit of the disclosure as disclosed in the accompanying claims.

Accordingly, the embodiments disclosed herein are not intended to limit the technical idea of the present disclosure, but rather to describe the technical idea of the present disclosure, and should not be construed as limiting the scope of the present disclosure.

The scope of protection of the present disclosure should be interpreted based on the claims below and all technical ideas within the equivalents thereto should be interpreted as falling into the scope of the present disclosure.

### REFERENCE NUMERAL

100: Composite film
120: Composite inorganic particles
121: Fluorinated polymer

What is claimed is:

1. A composite film having a configuration in which a plurality of composite inorganic particles comprising inorganic particles coated with a fluorinated polymer are sintered to form a plane shape.

2. The composite film according to claim 1, wherein the inorganic particles comprise silica (SiO₂) particles.

3. The composite film according to claim 2, wherein the silica particles comprise hollow silica or mesoporous silica particles.

4. The composite film according to claim 2, wherein a volume ratio of air contained in the film by the silica particles is 4.8 to 20.6% with respect to the total weight of the film.

5. The composite film according to claim 2, wherein the fluorinated polymer is located in at least a portion of pores of the silica particles.

6. The composite film according to claim 1, wherein the fluorinated polymer is polytetrafluoroethylene (PTFE).

7. The composite film according to claim 1, wherein the composite film comprises only the composite inorganic particles.

8. The composite film according to claim 1, wherein the composite film further comprises the fluorinated polymer.

9. The composite film according to claim 8, wherein the fluorinated polymer is present as a powder in an amount less than 15 w % of the composite film.

10. The composite film according to claim 9, wherein the fluorinated polymer is the same material as the fluorinated polymer that forms a coating layer of the composite inorganic particles.

11. The composite film according to claim 9, wherein the fluorinated polymer is a different material from the fluorinated polymer forming the coating layer of the composite inorganic particles.

12. The composite film according to claim 11, wherein the fluorinated polymer present as a powder is a perfluoroalkoxy (PFA) resin.

13. A method of manufacturing a composite film comprising:
surface-treating inorganic particles;
dispersing the inorganic particles in a solvent;
polymerizing the inorganic particles with a fluorinated polymer coating to form composite inorganic particles provided with a coating layer; and
pulverizing the composite inorganic particles and injecting the pulverized composite inorganic particles into a mold, followed by pressing and sintering, to manufacture a composite film.

14. The method according to claim 13, wherein the surface-treating the inorganic particles comprises treating the surface of the inorganic particles with reactive silane.

15. The method according to claim 13, wherein the surface-treating the inorganic particles imparts hydrophobicity to the inorganic particles.

16. The method according to claim 13, wherein the fluorinated polymer is polytetrafluoroethylene (PTFE).

17. The method according to claim 16, wherein the forming the composite inorganic particles comprises:
injecting the surface-treated inorganic particles and a polymerization initiator into a reactor; and
injecting a tetrafluoroethylene (TFE) monomer into the reactor and performing emulsion polymerization.

18. The method according to claim 13, wherein the dispersing the inorganic particles in the solvent comprises dispersing the inorganic particles in water in the presence of a fluorine-based emulsifier.

19. The method according to claim 13, wherein the inorganic particles comprise silica (SiO₂) particles.

20. The method according to claim 19, wherein the composite film is manufactured by injecting a fluorinated polymer powder along with the pulverized composite inorganic particles into the mold, followed by pressing and sintering.

21. The composite film according to claim 20, wherein the composite inorganic particles are present in an amount of 85 w % or more based on the total weight of the composite film.
